(19) United States
(12) Patent Application Publication
(10) Pub. No.: US 2011/0195197 A1
(43) Pub. Date: Aug. 11, 2011

(54) METHOD OF MANUFACTURING ULTRAVIOLET CROSS-LINKED FOAM INSULATED WIRE

(75) Inventors: Tomiya ABE, Takahagi (JP); Yoshihisa KATO, Hitachi (JP)

(73) Assignee: HITACHI CABLE, LTD., Tokyo (JP)

(21) Appl. No.: 12/795,810

(22) Filed: Jun. 8, 2010

(30) Foreign Application Priority Data
Feb. 10, 2010 (JP) 2010-027869

(51) Int. Cl. C08F 2/48

(52) U.S. Cl. 427/508

(57) ABSTRACT

A method of manufacturing an ultraviolet cross-linked foam insulated wire includes dissolving a gas in an ultraviolet curable resin composition, subsequently applying the ultraviolet curable resin composition on a conductor, and irradiating ultraviolet light on the ultraviolet curable resin composition to form a foam insulation layer on the conductor. The irradiating of ultraviolet light allows the resin composition to cure and bubbles to grow due to a decrease in solubility of the gas in the resin composition during the curing of the resin composition.

The present application is based on Japanese patent application No. 2010-027869 filed on Feb. 10, 2010, the entire contents of which are incorporated herein by reference.

### BACKGROUND OF THE INVENTION

1. Field of the Invention

The invention relates to a method of manufacturing an ultraviolet cross-linked foam insulated wire used for information technology devices, etc.

2. Description of the Related Art

According as the transmission rate of signal in information technology devices increases, a reduction in dielectric constant of a wire used therefor is desired. Therefore, a foam wire is desirably used which comprises a foam insulation formed by extruding, foaming and molding a polyethylene or fluorine resin.

In recent years, devices have been further downsized and become highly dense, and a wire used for the devices is required to have, e.g., an outer diameter of 0.3 mm or less. Since it becomes technically difficult to manufacture the thin wire by extrusion foaming, a method of manufacturing a foam wire is proposed in which an ultraviolet curable resin (i.e., a foamed resin) including gas or foaming agent is applied on a conductor and is then cured by ultraviolet light, as described in JP-B 3047686, JP-A 7-278333, JP-A 7-335053, JP-A 8-17256, JP-A 8-17257, JP-A 9-102230, JP-A 11-176262 and JP-A 11-297142. In addition, JP-A 2004-2812, JP-B 3963765 and WO2004/048064 propose forming fine bubbles.

Although the methods disclosed in JP-B 3047686, JP-A 7-278333, JP-A 7-335053, JP-A 8-17256, JP-A 8-17257, JP-A 9-102230, JP-A 11-176262 and JP-A 11-297142 are excellent in rapidly and efficiently forming a foam insulation layer (insulator layer), they are a process for forming a foam insulation layer while growing bubbles so that it is difficult to control the growth speed of the bubbles, and thus, there may disadvantageously occur a dispersion in foam ratio (i.e., ratio of bubbles to resin). In this regard, when the foaming ratio of the foam insulation layer is dispersed, a problem arises that dispersion may occur in the dielectric constant of the foam insulation layer and in the transmission characteristic of the foam wire to cause a signal delay.

JP-A 2004-2812 discloses a method of making fine bubbles using polymer including a compound which is decomposed by acid generated by exposure to light. However, since the generated acid causes corrosion in metal as a conductor, it is not possible to apply the method to the insulator layer of the wire.

Although JP-B 3963765 and WO2004/048064 disclose a method of making a porous film by removing an organic solvent in a humidified state when making a cast film, the method takes time in manufacture and it is problematic to apply the method to the manufacture of wires.

### SUMMARY OF THE INVENTION

Therefore, it is an object of the invention to provide a method of manufacturing an ultraviolet cross-linked foam insulated wire that the dispersion in foam ratio of a foam insulation layer can be suppressed to improve the productivity.

(1) According to one embodiment of the invention, a method of manufacturing an ultraviolet cross-linked foam insulated wire comprises:

dissolving a gas in an ultraviolet curable resin composition;

subsequently applying the ultraviolet curable resin composition on a conductor; and

irradiating ultraviolet light on the ultraviolet curable resin composition to form a foam insulation layer on the conductor,

wherein the irradiating of ultraviolet light allows the resin composition to cure and bubbles to grow due to a decrease in solubility of the gas in the resin composition during the curing of the resin composition.

In the above embodiment (1), the following modifications and changes can be made.

(i) The gas comprises carbon dioxide gas.

(ii) The he gas is dissolved in the ultraviolet curable resin composition by applying a high pressure and the high pressure is subsequently reduced to a normal pressure.

(2) According to another embodiment of the invention, a method of manufacturing an ultraviolet cross-linked foam insulated wire comprising a foam insulation layer formed on an outer periphery of a conductor by foaming an ultraviolet curable resin composition, comprising:

dissolving a gas in the ultraviolet curable resin composition by applying a high pressure;

reducing the high pressure applied to the ultraviolet curable resin composition to a normal pressure;

applying the ultraviolet curable resin composition on a conductor; and

irradiating an ultraviolet light on the ultraviolet curable resin composition applied on the conductor.

in the above embodiments (1) and (2), the following modifications and changes can be made.

(iii) The ultraviolet curable resin composition is applied onto the conductor without being foamed.

Points of the Invention

According to one embodiment of the invention, a method of manufacturing an ultraviolet cross-linked foam insulated wire is conducted such that an ultraviolet curable resin composition with a gas dissolved therein is applied onto a conductor without being foamed yet, and after the application, it is foamed and simultaneously cured by ultraviolet radiation to have a thin foam insulation layer with a high foam ratio. Thus, since no gas escapes or leaks from the foam insulation layer during the ultraviolet radiation, the foam insulation layer can include bubbles uniformly dispersed therein to exhibit uniform dielectric constant.

### BRIEF DESCRIPTION OF THE DRAWINGS

Next, the present invention will be explained in more detail in conjunction with appended drawings, wherein:

FIG. 1 is a cross sectional view showing an example of an ultraviolet cross-linked foam insulated wire of the present invention; and

FIG. 2 is a schematic view showing an example of a coating and curing apparatus used in the invention.

### DETAILED DESCRIPTION OF THE PREFERRED EMBODIMENTS

A preferred embodiment of the invention will be described in detail below in conjunction with the appended drawings.

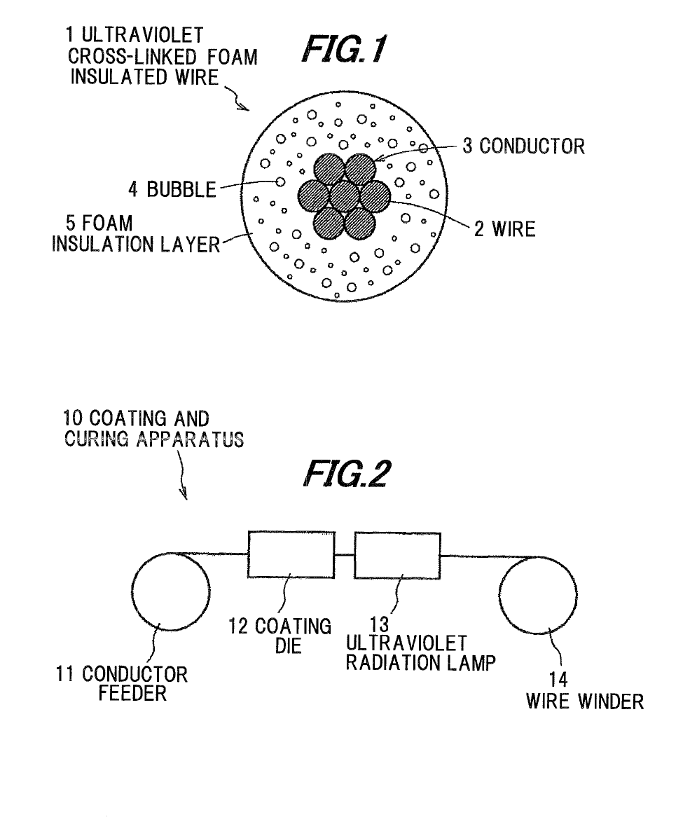

FIG. 1 is a cross sectional view showing an example of an ultraviolet cross-linked foam insulated wire of the invention.

As shown in FIG. 1, in an ultraviolet cross-linked foam insulated wire 1, a foam insulation layer (insulator layer) 5 with numerous fine bubbles 4 contained therein is formed on the outer periphery of a conductor 3 which is formed by twisting plural wires 2.

The wire 2 composing the conductor 3 is formed of a single metal such as copper, aluminum, iron or silver, or an alloy thereof. Although the conductor 3 is a twisted wire, it may be a single wire.

The foam insulation layer 5 is composed of an ultraviolet curable resin composition mainly containing polymerizable oligomer, polymerizable monomer and cross-linking initiator.

Here, the polymerizable oligomer has two or more of functional groups, e.g., an acryloyl group, a methacryloyl group, an acrylic group and a vinyl group, etc., which has an unsaturated bond such as, e.g., epoxy acrylate-based oligomer, epoxidized oil acrylate-based oligomer, urethane acrylate-based oligomer, polyester urethane acrylate-based oligomer, polyether urethane acrylate-based oligomer, polyester acrylate-based oligomer, polyether acrylate-based oligomer, vinyl acrylate-based oligomer, silicone acrylate-based oligomer, polybutadiene acrylate based oligomer, polystyrene ethyl methacrylate-based oligomer, polycarbonate dicarbonate-based oligomer, unsaturated polyester-based oligomer and polyene/thiol-based oligomer. A portion of these elements may be fluorine-substituted. In addition, these polymerizable oligomers can be used alone or as a blend.

The polymerizable monomer of the present embodiment is a polymerizable monomer which has two or more of an acryloyl group, a methacryloyl group, an acrylic group and a vinyl group, etc.

The cross-linking initiator of the present embodiment serves to produce a free radical by decomposition with light and starting curing of the polymerizable oligomer and the polymerizable monomer by the free radical.

Such a cross-linking initiator includes a benzoin ether-based compound, a ketal-based compound, an acetophenone-based compound and a benzophenone-based compound, etc.

In the present invention, the following other compositions can be appropriately blended if needed. In other words, such a composition includes an initiator aid, an anti-adhesion agent, a thixotropy-imparting agent, a filler, a plasticizer, a non-reactive polymer, a colorant, a flame retardant, a flame retardant aid, an anti-softening agent, a mold release agent, a desiccant agent, a dispersant, a wetting agent, an anti-precipitating agent, a thickener, an anti-electrification agent, an antistatic agent, a fungicide, a rat poison, a repellent for ants, a delustering agent, an anti-blocking agent, an antiskinning agent and a surfactant, etc.

The manufacturing method of the ultraviolet cross-linked foam insulated wire 1 will be described below.

FIG. 2 is a schematic view showing a coating and curing apparatus used to manufacture the ultraviolet cross-linked foam insulated wire 1.

As shown in FIG. 2, a coating and curing apparatus 10 includes a conductor feeder 11 on which the conductor 3 is wound, a coating die 12 for applying the above-mentioned ultraviolet curable resin composition on the outer periphery of the conductor 3 which is fed from the conductor feeder 11, a ultraviolet radiation lamp 13 as an ultraviolet radiation source for radiating the ultraviolet light on the ultraviolet curable resin composition which is applied by the coating die 12, and a wire winder 14 for winding the ultraviolet cross-linked foam insulated wire 1 of which the ultraviolet curable resin composition is cured by the ultraviolet radiation lamp 13. A low-pressure mercury lamp or a metal halide lamp, etc., may be used as the ultraviolet radiation lamp 13.

Firstly, the ultraviolet curable resin composition is placed in a pressure vessel, carbon dioxide is dissolved in the ultraviolet curable resin composition by applying pressure and the pressure is substantially returned to a normal level, and then, the ultraviolet curable resin composition is set in the coating die 12 of the coating and curing apparatus 10.

After that, the conductor 3 is fed out from the conductor feeder 11 so as to pass through the coating die 12, and the ultraviolet curable resin composition having the carbon dioxide dissolved therein is thereby applied on the conductor 3. The conductor 3 with the ultraviolet curable resin composition applied thereon is irradiated with ultraviolet by the ultraviolet radiation lamp 13, and the ultraviolet curable resin composition is then cured.

At this time, the ultraviolet curable resin composition is cured while the bubbles 4 are grown due to a decrease in solubility of gas at the time of the curing, which result in that fine bubbles are formed. As a result, a foam insulation layer 5 is formed on the outer periphery of the conductor 3 and the ultraviolet cross-linked foam insulated wire 1 is obtained.

As described above, in the method of manufacturing the ultraviolet cross-linked foam insulated wire of the invention, the ultraviolet curable resin composition to be applied on the conductor 3 is not foamed yet, but is foamed by the ultraviolet radiation after the application, and the ultraviolet curable resin composition is cured at the same time, thus, the foam insulation layer 5 is thin while having a high foam ratio. Therefore, the gas does not escape from the foam insulation layer 5, and the foam insulation layer 5 having the uniformly dispersed bubbles 4 is obtained.

In addition, in the method of manufacturing the ultraviolet cross-linked foam insulated wire of the invention, the ultraviolet cross-linked foam insulated wire 1 can be manufactured only by applying the ultraviolet curable resin composition on the conductor 3 and then irradiating the ultraviolet light thereon, thus, the productivity is high and it is useful for industrial purpose.

In this regard, the non-patent literary document of Polymer Processing Symposia '08, p 115-116 proposes a method of generating, growing and controlling bubbles with high efficiency, and the present invention proposes a method of manufacturing an ultraviolet cross-linked foam insulated wire by applying this technique.

In the non-patent literature document of Polymer Processing Symposia '08, p 115-116, an ultraviolet (UV) curable monomer is added to polystyrene (PS) to dissolve carbon dioxide (CO₂). In a material composition of this system, since the application to a component which receives stress by bending, etc., such as an insulator layer of a wire, is difficult, a urethane acrylate-based material, etc., excellent in stretch, etc., is used in the invention.

It is possible to manufacture only a film by the method of the non-patent literature document of Polymer Processing Symposia '08, p 115-116, however, it is difficult to form a coat on a wire. The present invention uses the coating and curing apparatus 10 on the basis of improvement in foaming efficiency and continuous coatability on a wire.

In addition, in the method of the non-patent literary document of Polymer Processing Symposia '08, p 115-116, pressure is applied and then is reduced, and the ultraviolet light is further irradiated on the composition after the reduced pressure foaming, thereby forming new bubbles. In contrast, in the invention, the composition in which carbon dioxide is dissolved by applying pressure is returned to normal pressure and is applied on the conductor 3 without being foamed. In a wire insulation layer formation process that the application and the foaming are continuously carried out, the application of foamed liquid makes difficult to control a foam ratio, a foam particle size and a film thickness of the insulation layer. Therefore, while the application process and the foaming process are carried out together in the non-patent literary document of Polymer Processing Symposia '08, p 115-116, the invention is devised such that the application process is separate from the foaming process.

Example of the method of manufacturing the ultraviolet cross-linked foam insulated wire of the invention will be described.

An ultraviolet curable resin composition, which is composed of 80.0 parts by mass of urethane acrylate-based oligomer as polymerizable oligomer, 20.0 parts by mass of monomer having acryloyl group as polymerizable monomer and 2 parts by mass of 1-hydroxy-cyclohexyl-phenyl-ketone (Irgacure® 184, manufactured by Chiba Speciality Chemicals Inc.) as cross-linking initiator, was obtained.

Next, the ultraviolet curable resin composition was placed in a pressure vessel and carbon dioxide was dissolved by applying pressure of 10 MPa. The ultraviolet curable resin composition having the carbon dioxide dissolved therein was returned to normal pressure, and the ultraviolet cross-linked foam insulated wire 1 was manufactured using the coating and curing apparatus 10 which is composed of the conductor feeder 11, the coating die 12, the ultraviolet radiation lamp 13 (metal halide lamp 1 kW), the wire winder 14 (at a winding speed of 60 m/min) as described in FIG. 2. Here, a twisted wire composed of 7 copper wires having a diameter of 25 μm was used as the conductor 3 and the ultraviolet cross-linked foam insulated wire 1 having a 40 μm thick foam insulation layer 5 was obtained. In the foam insulation layer 5 of the obtained ultraviolet cross-linked foam insulated wire 1, 60% of total volume of the insulator layer was the bubble 4 having the average particle diameter of 10 μm (measured by SEM: scanning microscope after cross sectioning) and the bubbles 4 were uniformly formed.

As described above, according to the method of manufacturing the ultraviolet cross-linked foam insulated wire of the invention, it is possible to suppress the dispersion in foam ratio of the foam insulation layer 5, and the ultraviolet cross-linked foam insulated wire 1 having uniform characteristics is thereby obtained.

Although the invention has been described with respect to the specific embodiment for complete and clear disclosure, the appended claims are not to be therefore limited but are to be construed as embodying all modifications and alternative constructions that may occur to one skilled in the art which fairly fall within the basic teaching herein set forth.

What is claimed is:

1. A method of manufacturing an ultraviolet cross-linked foam insulated wire, comprising:
dissolving a gas in an ultraviolet curable resin composition;
subsequently applying the ultraviolet curable resin composition on a conductor; and
irradiating ultraviolet light on the ultraviolet curable resin composition to form a foam insulation layer on the conductor,
wherein the irradiating of ultraviolet light allows the resin composition to cure and bubbles to grow due to a decrease in solubility of the gas in the resin composition during the curing of the resin composition.

2. The method according to claim 1, wherein the gas comprises carbon dioxide gas.

3. The method according to claim 1, wherein the gas is dissolved in the ultraviolet curable resin composition by applying a high pressure and the high pressure is subsequently reduced to a normal pressure.

4. A method of manufacturing an ultraviolet cross-linked foam insulated wire comprising a foam insulation layer formed on an outer periphery of a conductor by foaming an ultraviolet curable resin composition, comprising:
dissolving a gas in the ultraviolet curable resin composition by applying a high pressure;
reducing the high pressure applied to the ultraviolet curable resin composition to a normal pressure;
applying the ultraviolet curable resin composition on a conductor; and
irradiating an ultraviolet light on the ultraviolet curable resin composition applied on the conductor.

5. The method according to claim 1, wherein the ultraviolet curable resin composition is applied onto the conductor without being foamed.

6. The method according to claim 4, wherein the ultraviolet curable resin composition is applied onto the conductor without being foamed.
